(19) United States
(12) Patent Application Publication
(10) Pub. No.: US 2025/0384841 A1
(43) Pub. Date: Dec. 18, 2025

(54) DISPLAY DEVICE AND ELECTRONIC DEVICE INCLUDING THE SAME

(71) Applicant: Samsung Display Co., LTD., Yongin-si (KR)

(72) Inventors: Woung KIM, Yongin-si (KR); Chang Ho HYUN, Yongin-si (KR)

(21) Appl. No.: 19/013,569

(22) Filed: Jan. 8, 2025

(30) Foreign Application Priority Data
Jun. 18, 2024 (KR) 10-2024-0078881
Aug. 20, 2024 (KR) 10-2024-0111130

(51) Int. Cl. G09G 3/3266; G09G 3/00; G09G 3/3233

(52) U.S. Cl. CPC G09G 3/3266; G09G 3/035; G09G 3/3233; G09G 2300/0804; G09G 2300/0819; G09G 2310/0286; G09G 2310/06

(57) ABSTRACT

A display device includes: a display panel comprising pixels connected to data lines and scan lines, wherein the pixels are divided into first and second unit areas; a scan driver configured to provide scan signals to the scan lines; and a scan output unit connected between the scan driver and the display panel and configured to output the scan signals to the first and second unit areas, wherein the scan output unit is configured to output a first scan signal received from the scan driver to a first pixel in the first unit area of the pixels during a first period of a first horizontal period and to output the first scan signal to a second pixel in the second unit area of the pixels during a second period of the first horizontal period following the first period of the first horizontal period.

### CROSS-REFERENCE TO RELATED PATENT APPLICATION

The present application claims priority to and the benefit of Korean Patent Application No. 10-2024-0078881, filed on Jun. 18, 2024, and Korean Patent Application No. 10-2024-0111130, filed on Aug. 20, 2024, in the Korean Intellectual Property Office, the entire disclosures of which are incorporated herein by reference.

### BACKGROUND

### 1. Field

Aspects of some embodiments of the present disclosure relate to a display device and an electronic device including the same.

### 2. Description of the Related Art

With the development of information technology, the importance of display devices, which provide a connection medium between users and information, has increased. In line with this, the use of display devices such as liquid crystal display devices and organic light emitting display devices is increasing.

A display device generally includes a display panel including pixels, a scan driver sequentially applying scan signals to scan lines connected to rows of pixels, and a data driver applying data signals to data lines connected to columns of pixels.

The data driver may be connected to the display panel and provide data voltages to the pixels of the display panel through data lines. The pixels of the display panel may display images based on the data voltages received from the data driver.

The above information disclosed in this Background section is only for enhancement of understanding of the background and therefore the information discussed in this Background section does not necessarily constitute prior art.

### SUMMARY

Aspects of some embodiments of the present disclosure include a display device with relatively improved efficiency and an electronic device including the same. For example, the display device may reduce the number of driver integrated circuits by controlling a plurality of display areas with a single driver integrated circuit, thereby relatively reducing static power. In addition, by reducing the number of driver integrated circuits, it may be possible to save costs and relatively simplify processes.

A display device according to some embodiments of the present disclosure includes: a display panel including pixels connected to data lines and scan lines, wherein the pixels are divided into first and second unit areas; a scan driver providing scan signals to the scan lines; and a scan output unit connected between the scan driver and the display panel and optionally outputting the scan signals to the first and second unit areas, wherein the scan output unit outputs a first scan signal received from the scan driver to a first pixel in the first unit area of the pixels during a first period of a first horizontal period and outputs the first scan signal to a second pixel in the second unit area of the pixels during a second period of the first horizontal period following the first period of the first horizontal period.

According to some embodiments, the display device may further include a data driver connected to the pixels through the data lines, wherein the data driver may provide a first data voltage to the first pixel through a first data line of the data lines during the first period and provide a second data voltage to the second pixel through a second data line of the data lines during the second period.

According to some embodiments, the display device may further include a flexible film, wherein the display panel may further include a pad unit on one side of the display panel and includes a first data pad connected to the first pixel through the first data line of the data lines and a second data pad connected to the second pixel through the second data line of the data lines, and the flexible film may come into contact with the pad unit.

According to some embodiments, the data driver may be located on the flexible film, and the flexible film may include a first data output line connected to the first data pad and a second data output line connected to the second data pad.

According to some embodiments, the flexible film may include first and second layers, the first data output line may be included in the first layer, and the second data output line may be included in the second layer.

According to some embodiments, the scan output unit may include a demultiplexer that receives the first scan signal from the scan driver and optionally outputs the first scan signal to the first and second pixels in response to a selection signal.

According to some embodiments, the demultiplexer may receive the first scan signal from the scan driver through one of the scan lines during the first and second periods, output the first scan signal to a first sub-scan line connected to the first pixel in response to the selection signal having a first logic level during the first period, and output the first scan signal to a second sub-scan line connected to the second pixel in response to the selection signal having a second logic level during the second period.

According to some embodiments, the first and second pixels may be positioned in the same pixel row, the first pixel may be connected to a first data line of the data lines and connected to the demultiplexer through the first sub-scan line, and the second pixel may be connected to a second data line of the data lines and connected to the demultiplexer through the second sub-scan line.

According to some embodiments, the scan output unit may receive a second scan signal from the scan driver, output the second scan signal to a third pixel located in the first unit area of the pixels during a first period of a second horizontal period following the first horizontal period, and output the second scan signal to a fourth pixel located in the second unit area of the pixels during a second period of the second horizontal period following the first period of the second horizontal period.

According to some embodiments, the first and second pixels may be positioned in a first pixel row, and the third and fourth pixels may be positioned in a second pixel row that is different from the first pixel row.

According to some embodiments, the first and third pixels may be connected to a first data line of the data lines, and the second and fourth pixels may be connected to a second data line of the data lines.

According to some embodiments, the scan output unit may include a demultiplexer that receives the second scan signal from the scan driver and optionally outputs the second scan signal to the third and fourth pixels in response to a selection signal.

According to some embodiments, the scan driver may include a plurality of scan stages that output the scan signals.

According to some embodiments, the pixels may be further connected to emission control lines and the display device may further include an emission driver that provides emission control signals to the emission control lines.

According to some embodiments, the display device may further include an emission output unit that is connected between the emission driver and the display panel and optionally outputs the emission control signals to the first and second unit areas.

According to some embodiments, the emission output unit may output a first emission control signal received from the emission driver to the first pixel during the first period and output the first emission control signal to the second pixel during the second period.

According to some embodiments, the emission output unit may include a demultiplexer that receives the first emission control signal from the emission driver and optionally outputs the first emission control signal to the first and second pixels in response to a selection signal.

According to some embodiments, the emission output unit may receive the first emission control signal from the emission driver through one of the emission control lines during the first and second periods, output the first emission control signal to a first sub-emission control line connected to the first pixel in response to the selection signal having a first logic level during the first period, and output the first emission control signal to a second sub-emission control line connected to the second pixel in response to the selection signal having a second logic level during the second period.

An electronic device according to some embodiments includes: a processor; and a display device that displays an image based on input image data received from the processor, wherein the display device includes: a display panel including pixels that are connected to data lines and scan lines, wherein the pixels are divided into first and second unit areas; a scan driver providing scan signals to the scan lines; and a scan output unit connected between the scan driver and the display panel and optionally outputting the scan signals to the first and second unit areas, wherein the scan output unit outputs a first scan signal received from the scan driver to a first pixel located in a first unit area of the pixels during a first period of a first horizontal period and outputs the first scan signal to a second pixel located in the second unit area of the pixels during a second period of the first horizontal period following the first period of the first horizontal period.

### BRIEF DESCRIPTION OF THE DRAWINGS

FIG. 1 is a perspective view of a display device according to some embodiments of the present disclosure.

FIG. 2 is a block diagram illustrating aspects of a display device of FIG. 1.

FIG. 3 is a block diagram illustrating aspects of any one of pixels of FIG. 2.

FIG. 4 is a plan view illustrating aspects of a plurality of unit areas included in a display panel of FIG. 2.

FIG. 5 is a block diagram illustrating further details of unit areas, a scan driver, and a scan output unit of a display panel.

FIG. 6 is a timing diagram illustrating signals associated with the scan output unit of FIG. 5.

FIG. 7 is a block diagram illustrating aspects of a portion of a display panel and a data driver.

FIG. 8 is a block diagram illustrating aspects of a data driver of FIG. 2.

FIG. 9 is a plan view illustrating aspects of a plurality of unit areas included in a display panel of FIG. 2.

FIG. 10 is a block diagram illustrating aspects of an emission driver and an emission output unit of FIG. 2.

FIG. 11 is a schematic block diagram illustrating aspects of an electronic device including a display device according to some embodiments of the present disclosure.

### DETAILED DESCRIPTION

Hereinafter, aspects embodiments will be described in detail with reference to the accompanying drawings. It should be noted that the following explanation describes only parts necessary to understand the operation according to the present disclosure, and descriptions of other parts will be omitted not to obscure the gist of the present disclosure. In addition, the present disclosure is not limited to the embodiments described herein, but may be embodied in other forms. However, the embodiments described herein is provided to explain in such detail as to facilitate implementation of the technical idea of the present disclosure to a person skilled in the art to which the present disclosure pertains.

Throughout the specification, if a part is “connected” to another part, this includes not only a case where they are “directly connected”, but also a case where they are “indirectly connected” with another element interposed therebetween. Terminology used herein is intended to describe specific embodiments and is not intended to limit the present disclosure. Throughout the specification, if a part “comprises” or “includes” a component, it means that it may further include other component rather than excluding other components unless the context indicates otherwise. “At least any one of X, Y, and Z” and “at least any one selected from a group of X, Y, and Z” may be interpreted as one X, one Y, one Z, or a combination of two or more of X, Y, and Z (e.g., XYZ, XYY, YZ, ZZ). Herein, “and/or” includes all combinations of one or more of corresponding configurations.

Herein, terms such as first and second may be used to describe various components, but these components are not limited to these terms. These terms are used to distinguish one component from another component. Accordingly, a first component may be referred to as a second component without departing from the present disclosure.

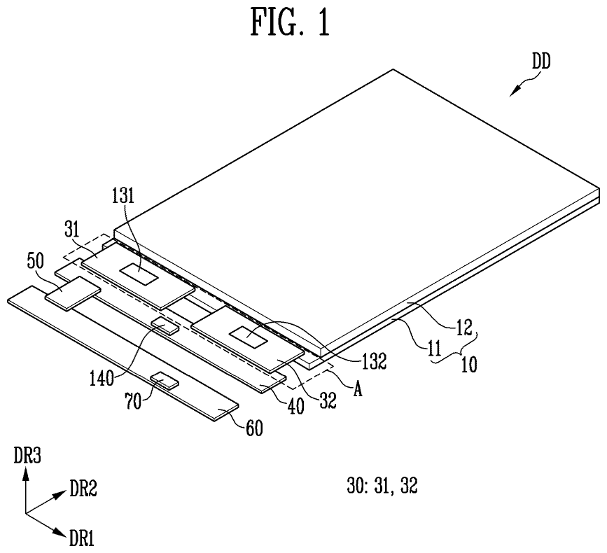

FIG. 1 is a perspective view of a display device according to some embodiments of the present disclosure.

Referring to FIG. 1, a display device (DD) may include a display panel 10, flexible films 30, a first printed circuit board (PCB) 40, a connector 50, a second printed circuit board 60, a timing controller (T-con) 140, and a host system 70. The flexible films 30 may include driver integrated circuits (DIC) 131 and 132.

The display panel 10 may include a lower substrate 11 and an upper substrate 12. The lower substrate 11 may be a thin-film transistor substrate consisting of plastic or glass. The upper substrate 12 may be a plastic film, a glass substrate, or an encapsulated substrate made of a protective film.

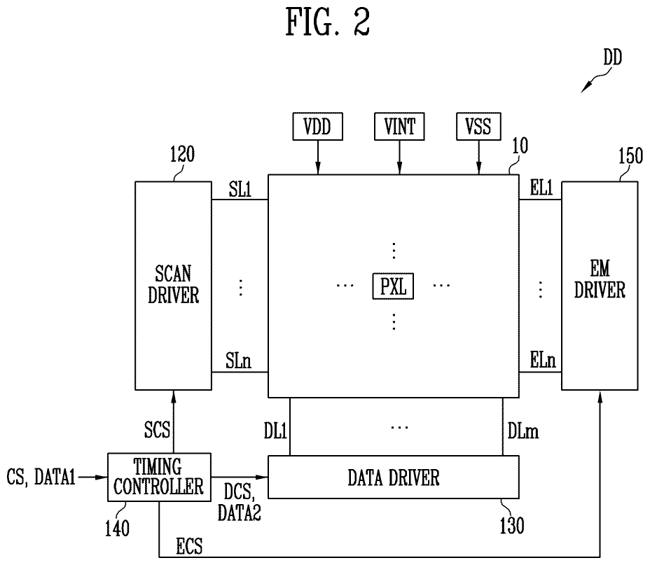

The lower substrate 11 may include a display area and a non-display area provided around (e.g., in a periphery or outside a footprint of) the display area. The display area may be an area where pixels (PXL, see FIG. 2) are provided to display images. On the lower substrate 11, scan lines (SL1˜SLn, see FIG. 2), data lines (DL1˜DLm, see FIG. 2), and emission control lines (EL1˜ELn, see FIG. 2) may be located.

The display panel 10 may include a scan driver 120 (see FIG. 2) formed in a gate driver in panel (GIP) manner in the non-display area on one or both edges of the display area.

The driver integrated circuits 131 and 132 may include a data driver 130 (see FIG. 2). For example, the data driver 130 may be included in the driver integrated circuits 131 and 132. However, embodiments according to the present disclosure are not limited thereto. For example, the driver integrated circuits 131 and 132 may further include the data driver 130 and an emission driver 150 (see FIG. 2). In this case, the data driver 130 and the emission driver 150 may be functionally distinct components in the driver integrated circuits 131 and 132. According to some embodiments, the emission driver 150 may be provided as a distinct component from the driver integrated circuits 131 and 132.

The driver integrated circuits 131 and 132 may be mounted in the flexible films 30. The first driver integrated circuit 131 may be mounted in a first flexible film 31, and the second driver integrated circuit 132 may be mounted in a second flexible film 32.

The first and second flexible films 31 and 32 may be attached onto pads provided on the lower substrate 11. The driver integrated circuits 131 and 132 mounted in the flexible films 30 may be connected to the data lines (DL1˜DLm) through pads.

The first and second flexible films 31 and 32 may be provided on the lower substrate 11 in a Film On Plastic (FOP) manner. However, embodiments according to the present disclosure are not limited thereto. Thus, the first and second flexible films 31 and 32 may be curved or bent respectively. The first and second flexible films 31 and 32 may be attached to the lower substrate 11 of the display panel 10 and the first printed circuit board 40.

The first printed circuit board 40 may be attached to the first and second flexible films 31 and 32. The first printed circuit board 40 may be mounted with the timing controller 140. The first printed circuit board 40 may be a flexible printed circuit board (FPCB). The first printed circuit board 40 may be connected to the second printed circuit board 60 through the connector 50.

The first printed circuit board 40 may be mounted with the timing controller 140. The timing controller 140 may be connected to the first and second flexible films 31 and 32 through the first printed circuit board 40. The timing controller 140 may be connected to the driver integrated circuits 131 and 132.

The connector 50 may connect the first printed circuit board 40 and the second printed circuit board 60. The connector 50 may be a plurality of wirings, including a bus which is an input/output terminal applied with an intra interface between the timing controller 140 and the host system 70. The intra interface may be an interface capable of processing a plurality of input data at a high rate. However, embodiments according to the present disclosure are not limited thereto. For example, the connector 50 may be a plurality of wirings including any interface and any input/output terminal capable of transmitting data.

The second printed circuit board 60 may be mounted with the host system 70. The second printed circuit board 60 may be connected to the first printed circuit board 40 through the connector 50. The host system 70 may include a System on Chip (SoC) with a scaler built therein.

FIG. 2 is a block diagram illustrating aspects of the display device of FIG. 1.

Referring to FIG. 2, the display device (DD) may include the display panel 10, the scan driver 120 (or a gate driver), the data driver 130 (or a source driver), the timing controller 140, and the emission driver 150.

The display panel 10 may include the scan lines (SL1˜SLn, where n is a positive integer) (or gate lines), data lines (DL1˜DLm, where m is a positive integer), emission control lines (EL1˜ELn), and pixels (PXL). The pixels (PXL) may be located in an area (e.g., a pixel area) compartmentalized by the scan lines (SL1˜SLn), data lines (DL1˜DLm), and emission control lines (EL1˜ELn).

Each pixel (PXL) may include at least one light emitting element that is configured to generate light. Accordingly, the pixels (PXL) may each generate light of a specific color, such as red, green, blue, cyan, magenta, and yellow.

The pixels (PXL) may be connected to the scan driver 120 through the first to n-th scan lines (SL1˜SLn). The pixels (PXL) may be connected to the data driver 130 through the first to m-th data lines (DL1˜DLm). The pixels (PXL) may be connected to the emission driver 150 through the first to n-th emission control lines (EL1˜ELn).

First and second power supply voltages (VDD, VSS) may be provided in the display panel 10. The First and second power supply voltages (VDD, VSS) may be the voltages required for an operation of the pixels (PXL). The first power supply voltage (VDD) may have a voltage level higher than that of the second power supply voltage (VSS). In addition, the display panel 10 may be provided with an initialization power supply voltage (VINT). The first and second power supply voltages (VDD, VSS) and the initialization power supply voltage (VINT) may be provided by an external device of the display device (DD).

The scan driver 120 may generate a scan signal based on a scan control signal (SCS). The scan driver 120 may provide the scan signal to the scan lines (SL1˜SLn) sequentially. Here, the scan control signal (SCS) may include initiation signals and clock signals and be provided from the timing controller 140. For example, the scan driver 120 may include a shift register (or a stage) that uses clock signals to sequentially generate and output a pulsed scan signal corresponding to a pulsed initiation signal.

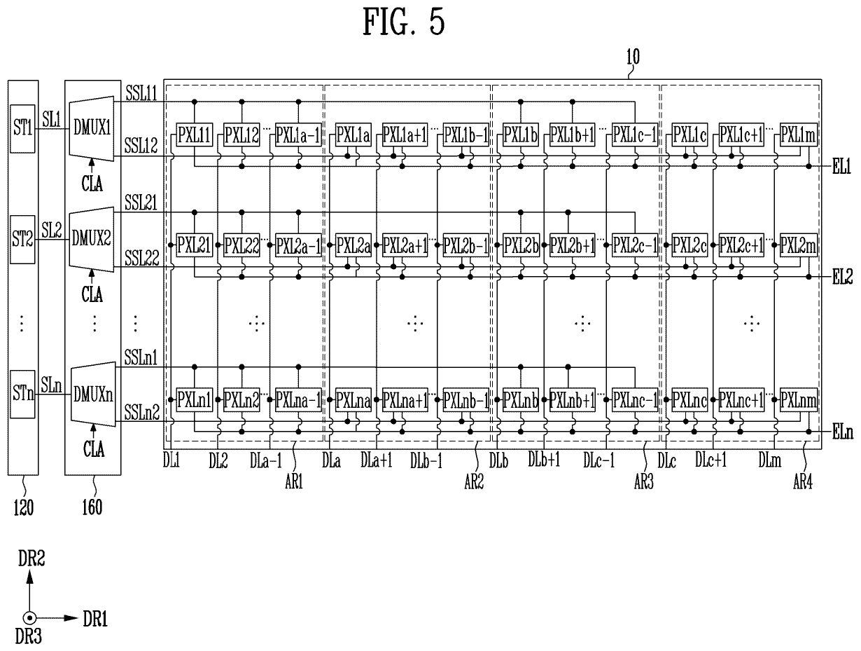

In addition, according to some embodiments, the scan driver 120 may provide the scan signal to the display panel 10 through a scan output unit 160 (see FIG. 5). For example, the scan driver 120 may optionally provide scan signals to the pixels (PXL) that are divided into a plurality of unit areas through the scan output unit 160 (see FIG. 5). Details of the scan output unit 160 are described below in reference to FIG. 5.

The scan driver 120 may be located on one side of the display panel 10. However, embodiments are not limited thereto. For example, the scan driver 120 may be divided into two or more physically and/or logically distinct drivers, and such drivers may be located on one side of the display panel 10 and on the other side of the display panel 10 that is opposed to the other. Thus, the scan driver 120 may be arranged around the display panel 10 in various forms according to the embodiments.

The emission driver 150 may generate an emission control signal based on an emission driving control signal (ECS). The emission driver 150 may provide the emission control signal to the emission control lines (EL1˜ELn) sequentially or simultaneously. Here, the emission driving control signal (ECS) may include light emitting initiation signals and light emitting clock signals and be provided from the timing controller 140. For example, the emission driver 150 may include the shift register that uses the light emitting clock signals to sequentially generate and output the pulsed emission control signal corresponding to the pulsed light emitting initiation signal.

The data driver 130 may generate data signals based on image data (DATA2) and data control signals (DCS) provided from the timing controller 140. The data driver 130 may provide the data signals to the display panel 10 (or pixels (PXL)). Here, the data control signal (DCS) may be a signal that controls the operation of the data driver 130 and include a load signal (or a data enabling signal) that directs the output of the effective data signal. For example, the data driver 130 may generate gamma voltages and output the data signal (or a data voltage) by selecting one of the gamma voltages corresponding to gray scale values in the image data (DATA2),

The timing controller 140 may control all the operations of the display device (DD). The timing controller 140 may receive input image data (DATA1) and a control signal (CS) from the host system 70 (see FIG. 1). The timing controller 140 may generate the scan control signal (SCS) and the data control signal (DCS) based on the control signal (CS). The timing controller 140 may convert the input image data (DATA1) to generate the image data (DATA2). Here, the control signal (CS) may include a vertical synchronous signal, a horizontal synchronous signal, and a clock. The vertical synchronous signal may indicate the initiation of frame data (i.e., data corresponding to the frame segment on which a single frame image is displayed). The horizontal synchronous signal may indicate the initiation of a data row (i.e., a data row in one of a plurality of data rows included in the frame data). For example, the timing controller 140 may convert the input image data (DATA1) in RGB format to image data (DATA2) in RGBG format corresponding to the pixel arrangement in the display panel 10.

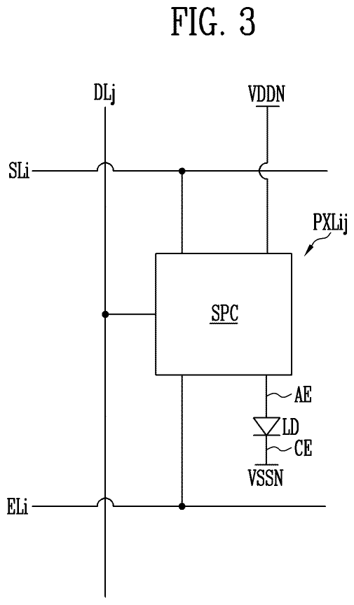

FIG. 3 is a block diagram illustrating aspects of any one of pixels of FIG. 2. In FIG. 3, the pixel (PXLij) arranged in an i-th row (where i is an integer greater than or equal to 1 and less than or equal to n) and a j-th column (where j is an integer greater than or equal to 1 and less than or equal to m) of the pixels (PXL) of FIG. 2 are illustratively shown.

Referring to FIG. 3, the pixel (PXLij) may include a pixel circuit (PXC) and a light emitting element (LD).

The light emitting element (LD) may be connected between a first power supply voltage node (VDDN) and a second power supply voltage node (VSSN). The first power supply voltage node (VDDN) may receive the first power supply voltage (VDD) among the voltages of FIG. 2. The second power supply voltage node (VSSN) may receive the second power supply voltage (VSS) of the voltages of FIG. 2. The first power supply voltage (VDD) may have a higher voltage level than the second power supply voltage (VSS).

The light emitting element (LD) may be connected between an anode electrode (AE) and a cathode electrode (CE). The anode electrode (AE) may be connected to the first power supply voltage node (VDDN) through the pixel circuit (PXC). For example, the anode electrode (AE) may be connected to the first power supply voltage node (VDDN) through one or more transistors included in the pixel circuit (PXC). The cathode electrode (CE) may be connected to the second power supply voltage node (VSSN). The light emitting element (LD) may be configured to emit light according to current flowing from the anode electrode (AE) to the cathode electrode (CE).

The pixel circuit (PXC) may be connected to an i-th scan line (SLi) of the first to n-th scan lines (SL1˜SLn) of FIG. 2, an i-th emission control lines (ELi) of the first to n-th emission control lines (EL1˜ELn) of FIG. 2, and a j-th data line (DLj) of the first to m-th data lines (DL1˜DLm) of FIG. 2. In response to the scan signal received through the i-th scan line (SLi), the pixel circuit (PXC) may control the light emitting element (LD) to emit light according to the data signal received through the j-th data line (DLj). According to some embodiments, the pixel circuits (PXC) may be further connected to pixel control lines (PXCL) of FIG. 1. The pixel circuit (PXC) may control the light emitting element (LD) by responding more to the emission control signals received through the i-th emission control line (ELi).

For these operations, the pixel circuit (PXC) may include circuit elements, such as transistors and one or more capacitors.

Transistors in the pixel circuits (PXC) may include P-type transistors and/or N-type transistors. According to some embodiments, the transistors in the pixel circuits (PXC) may include metal oxide silicon field effect transistor (MOSFET). According to some embodiments, transistors in the pixel circuit (PXC) may include amorphous silicon semiconductors, monocrystalline silicon, polycrystalline silicon semiconductors, and oxide semiconductors.

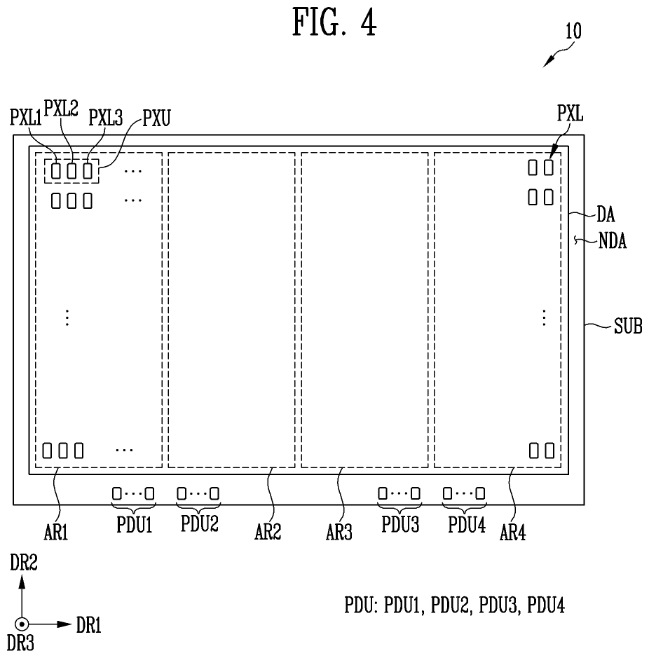

FIG. 4 is a plan view illustrating aspects of a plurality of unit areas included in a display panel of FIG. 2.

Referring to FIG. 4, the display panel (DP) may include the display area (DA) and the non-display area (NDA). The display panel (DP) may display images through the display area (DA). The non-display area (NDA) may be arranged around (e.g., in a periphery or outside a footprint of) the display area (DA).

The display panel (DP) may include pixels (PXL) in the display area (DA). The pixel (PXL) may be arranged along a first direction (DR1) and a second direction (DR2) crossing (e.g., perpendicular to) with the first direction (DR1). For example, the pixels (PXL) may be arranged in a matrix form or arrangement along the first direction (DR1) and the second direction (DR2). According to some embodiments, the pixels (PXL) may be arranged in a zigzag form along the first direction (DR1) and the second direction (DR2). The arrangement of the pixels (PXL) may vary according to the embodiments. The first direction (DR1) may be a row direction, and the second direction (DR2) may be a column direction.

Two or more pixels of a plurality of pixels (PXL) may form a single pixel unit (PXU). In FIG. 4, the pixel unit (PXU) is shown to include three pixels (PXL1˜PXL3), but the embodiments are not limited thereto. For example, the pixel unit (PXU) may include two pixels. Hereinafter, for the convenience of explanation, it is assumed that the pixel unit (PXU) includes the first to third pixels (PXL1˜PXL3).

Each of the first to third pixels (PXL1˜PXL3) may include at least one light emitting element configured to generate light. According to some embodiments, the light emitting elements of the first to third pixels (PXL1˜PXL3) may generate light of the same color. For example, light emitting elements of the first to third pixels (PXL1˜PXL3) may generate blue light. According to some embodiments, the light emitting elements of the first to third pixels (PXL1˜PXL3) may generate light of different colors. For example, the light emitting elements of the first to third pixels (PXL1˜PXL3) may generate red, green, and blue light, respectively.

As the display panel (DP), display panels capable of self-emitting light, such as a light emitting diode (LED) display panel that uses a microscale or nanoscale light emitting diode as a light emitting element or an organic light emitting display (OLED) panel that uses an organic light emitting diode as a light emitting element, may be used. However, embodiments according to the present disclosure are not limited thereto.

The pixels (PXL) may be divided into a plurality of unit areas. The pixels (PXL) may be divided into a plurality of unit areas depending on the number of driver integrated circuits (e.g., data driver integrated circuits). As shown in FIG. 1, if the display device (DD) includes two driver integrated circuits 131 and 132, the pixels (PXL) may be divided into 1 to 4 units areas (AR1˜AR4). Here, the first to fourth unit areas (AR1˜AR4) may be arranged side by side along the first direction (DR1). However, embodiments according to the present disclosure are not limited thereto. For example, the first to fourth unit areas (AR1˜AR4) may be arranged side by side along the second direction (DR2).

According to some embodiments, the pixels of the first unit area (AR1) and the pixels of the second unit area (AR2) may be controlled by the first driver integrated circuit 131. The pixels of the third unit area (AR3) and the pixels of the fourth unit area (AR4) may be controlled by the second driver integrated circuit 132. For example, a first horizontal period may include a first period and a second period that are consecutive. In this case, the scan signals may be provided to the pixels of the first and third unit areas (AR1, AR3) of the pixels (PXL) during the first period of the first horizontal period. Scan signals may be provided to the pixels of the second and fourth unit areas (AR2, AR4) of the pixels (PXL) during the second period of the first horizontal period.

In the non-display area (NDA), a component for controlling the pixels (PXL) may be located. Wirings connected with the pixels (PXL) may be arranged, e.g., the first to n-th scan lines (SL1˜SLn), the first to m-th data lines (DL1˜DLm), the first to n-th emission control lines (EL1˜ELn), and power supply lines of FIG. 3 may be located in the non-display area (NDA).

In the non-display area (NDA), pad units (PDU) connected with the first to m-th data lines (DL1˜DLm) may be located. For example, the pad units (PDU) may include first to fourth pad units (PDU1˜PDU4). The first pad unit (PDU1) may be connected to first group data lines (DL1˜DLa−1, see FIG. 5) that are connected to the pixels of the first unit area (AR1). The second pad unit (PDU2) may be connected to second group data lines (DLa˜DLb−1, see FIG. 5) that are connected to the pixels of the second unit area (AR2). The third pad unit (PDU3) may be connected to third group data lines (DLb˜DLc−1, see FIG. 5) that are connected to the pixels of the third unit area (AR3). The fourth pad unit (PDU4) may be connected to fourth group data lines (DLc˜DLm, see FIG. 5) that are connected to the pixels of the fourth unit area (AR4).

According to some embodiments, the first to fourth pad units (PDU1˜PDU4) may be located in an area overlapping with the first and second flexible films 31 and 32 of FIG. 1 on a substrate (SUB). For example, the first and second pad units (PDU1, PDU2) may be arranged to overlap the first flexible film 31. The third and fourth pad units (PDU3, PDU4) may be arranged to overlap the second flexible film 32.

The first to fourth pad units (PDU1˜PDU4) may be electrically bonded to the first and second flexible films 31 and 32. For example, the first to fourth pad units (PDU1˜PDU4) may be electrically connected to the first and second flexible films 31 and 32 on the upper surface of the substrate (SUB).

According to some embodiments, the display area (DA) may have a variety of shapes. The display area (DA) may have a shape of a closed loop including straight and/or curved sides. For example, the display area (DA) may have shapes such as polygons, circles, semicircles, and ellipses.

According to some embodiments, the display panel (DP) may have a flat display surface. In other embodiments, the display panel (DP) may have at least a partially rounded display surface. According to some embodiments, the display panel (DP) may be bendable, foldable, or rollable. In these cases, the display panel (DP) and/or the substrate of the display panel (DP) may include materials having flexibility.

FIG. 5 is a block diagram illustrating aspects of unit areas, a scan driver, and a scan output unit of a display panel.

Referring to FIG. 5, the display device (DD) may include the display panel 10, the scan driver 120, and the scan output unit 160. The scan driver 120 and the scan output unit 160 may be included in the scan driver 120 of FIG. 2.

The display panel 10 may include first sub-scan lines (SSL11˜SSLn1), second sub-scan lines (SSL12˜SSLn2), and pixels (PXL11˜PXLnm) connected to data lines (DL1˜DLm). Here, the first sub-scan lines (SSL11˜SSLn1) and the second sub-scan lines (SSL12˜SSLn2) may extend in the first direction (DR1) to be arranged in parallel to each other. The data lines (DL1˜DLm) may extend in the second direction (DR2) to be arranged to cross the first sub-scan lines (SSL11˜SSLn1) and the second sub-scan lines (SSL12˜SSLn2) (e.g., in a plan view).

The pixels (PXL11˜PXLnm) may be divided into a plurality of unit areas. The pixels (PXL11˜PXLnm) may be divided into pixels (PXL11˜PXL1a−1, PXL21˜PXL2a−1, . . . , PXLn1˜PXLna−1, where a is a positive integer greater than 1) of the first unit area (AR1), pixels (PXL1a˜PXL1b−1, PXL2aPXL2b−1, . . . , PXLna˜PXLnb−1, where b is an integer greater than a) of the second unit area (AR2), pixels (PXL1b˜PXL1c−1, PXL2bPXL2c−1, . . . , PXLnb˜PXLnc−1, where c is a positive integer greater than b) of the third unit area (AR3), and pixels (PXL1c˜PXL1m, PXL2cPXL2m, . . . , PXLnc˜PXLnm, where m is a positive integer greater than c) of the fourth unit area (AR4). However, embodiments according to the present disclosure are not limited thereto.

The pixels (PXL11˜PXL1a−1, PXL21˜PXL2a−1, . . . , PXLn1˜PXLna−1) of the first unit area (AR1) may be connected to one of the first sub-scan lines (SSL11˜SSLn1) and the first group data lines (DL1˜DLa−1). The pixels (PXL1a˜PXL1b−1, PXL2aPXL2b−1, . . . , PXLna˜PXLnb−1) of the second unit area (AR2) may be connected to one of the second sub-scan lines (SSL12˜SSLn2) and the second group data lines (DLa˜DLb−1). The pixels (PXL1b˜PXL1c−1, PXL2bPXL2c−1, . . . , PXLnb˜PXLnc−1) of the third unit area (AR3) may be connected to one of the first sub-scan lines (SSL11˜SSLn1) and the third group data lines (DLb˜DLc−1). In addition, the pixels (PXL1c˜PXL1m, PXL2cPXL2m, . . . , PXLnc˜PXLnm) of the fourth unit area (AR4) may be connected to the second sub-scan lines (SSL12˜SSLn2) and one of the fourth group data lines (DLc˜DLm).

The scan driver 120 may be connected to a plurality of scan lines (SL1˜SLn) and generate scan signals according to the scan control signal (SCS, see FIG. 2) to provide to the scan lines (SL1˜SLn). According to some embodiments, the scan control signal (SCS) may include a plurality of clock signals, and the scan driver 120 may sequentially apply the scan signals to the scan lines (SL1˜SLn) synchronously with the plurality of clock signals.

The scan driver 120 may include a plurality of scan stages (ST1˜STn) (or scan stage circuits). The scan stages (ST1˜STn) may each be connected to the scan lines (SL1˜SLn), and the scan stages (ST1˜STn) may provide the scan signals to the scan lines (SL1˜SLn) sequentially. For example, the first scan stage (ST1) may provide a first scan signal to the first scan line (SL1). The second scan stage (ST2) may provide a second scan signal to the second scan line (SL2). The n-th scan stage (STn) may provide the n-th scan signal to the n-th scan line (SLn). For example, the scan driver 120 may include n scan stages (ST1˜STn) corresponding to n pixel rows.

The scan output unit 160 may be connected between the scan driver 120 and the display panel 10. The scan output unit 160 may optionally output the scan signals provided from the scan driver 120 to the first to fourth unit areas (AR1˜AR4) of the display panel 10.

The scan output unit 160 may output the scan signal received from the scan driver 120 to the pixels (PXL11˜PXL1a−1, PXL21˜PXL2a−1, . . . , PXLn1˜PXLna−1) of the first unit area (AR1) and the pixels (PXL1b˜PXL1c−1, PXL2bPXL2c−1, . . . , PXLnb˜PXLnc−1) of the third unit area (AR3) during the first period of a single horizontal period. In addition, the scan output unit 160 may output the scan signal received from the scan driver 120 to the pixels (PXL1a˜PXL1b−1, PXL2aPXL2b−1, . . . , PXLna˜PXLnb−1) of the second unit area (AR2) and the pixels (PXL1c˜PXL1m, PXL2cPXL2m, . . . , PXLnc˜PXLnm) of the fourth unit area (AR4) during the second period of a single horizontal period. The scan output unit 160 may alternately output scan signals to the first and third unit areas (AR1, AR3) and the second and fourth unit areas (AR2, AR4) during a single horizontal period.

According to some embodiments, the scan output unit 160 may include demultiplexers (DMUX1˜DMUXn). The scan output unit 160 may include demultiplexers (DMUX1˜DMUXn) that are connected to scan lines (SL1˜SLn) and sub-scan lines (SSL11˜SSLn1, SSLL12˜SSLn2). For example, the demultiplexers (DMUX1˜DMUXn) may have one input terminal and two output terminals. Here, the input terminal may be connected to one of the scan lines (SL1˜SLn) to allow the scan signals to be input. In addition, the output terminals may be connected to one of the first sub-scan lines (SSL11˜SSLn1) and one of the second sub-scan lines (SSL12˜SSLn2) to optionally output scan signals. Each of the demultiplexers (DMUX1˜DMUXn) may output the scan signal by time sharing through the corresponding output terminals in response to a selection signal (CLA). More specifically, each of the demultiplexers (DMUX1˜DMUXn) may output the scan signal, which is input to a single input terminal, to an output terminal selected by the selection signal (CLA) among two output terminals. For example, the scan output unit 160 may include n demultiplexers (DMUX1˜DMUXn) corresponding to n pixel rows.

For example, the demultiplexers (DMUX1˜DMUXn) may be connected to scan stages (ST1˜STn) through the scan lines (SL1˜SLn). For example, the first demultiplexer (DMUX1) may be connected to the first scan stage (ST1) through the first scan line (SL1). The second demultiplexer (DMUX2) may be connected to the second scan stage (ST2) through the second scan line (SL2). The n-th demultiplexer (DMUXn) may be connected to the n-th scan stage (STn) through the n-th scan line (SLn).

The demultiplexers (DMUX1˜DMUXn) may be connected to the pixels located in the first and third unit areas (AR1, AR3) through the first sub-scan lines (SSL11˜SSLn1). In addition, the demultiplexers (DMUX1˜DMUXn) may be connected to the pixels located in the second and fourth unit areas (AR2, AR4) through the second sub-scan lines (SSL12˜SSLn2).

For example, the first demultiplexer (DMUX1) may be connected to the first row pixels (PXL11˜PXL1a−1) of the first unit area (AR1) and the first row pixels (PXL1b˜PXL1c−1) of the third unit area (AR3) through the first sub-scan line (SSL11) of the first row. In addition, the first demultiplexer (DMUX1) may be connected to the first row pixels (PXL1a˜PXL1b−1) of the second unit area (AR2) and the first row pixels (PXL1c˜PXL1m) of the fourth unit area (AR4) through the second sub-scan line (SSL12) of the first row.

The second demultiplexer (DMUX1) may be connected to the second row pixels (PXL21˜PXL2a−1) of the first unit area (AR1) and the second row pixels (PXL2b˜PXL2c−1) of the third unit area (AR3) through the first sub-scan line (SSL21) of the second row. In addition, the second demultiplexer (DMUX2) may be connected to the second row pixels (PXL2a˜PXL2b−1) of the second unit area (AR2) and the second row pixels (PXL2c˜PXL2m) of the fourth unit area (AR4) through the second sub-scan line (SSL22) of the second row.

The n-th demultiplexer (DMUXn) may be connected to the n-th row pixels (PXLn1˜PXLna−1) of the first unit area (AR1) and the n-th row pixels (PXLnb˜PXLnc−1) of the third unit area (AR3) through the first sub-scan line (SSLn1) of the n-th row. Then, the n-the demultiplexer (DMUX2) may be connected to the n-th row pixels (PXLna˜PXLnb−1) of the second unit area (AR2) and the n-th row pixels (PXLnc˜PXLnm) of the fourth unit area (AR4) through the second sub-scan line (SSLn2) of the n-th row.

According to some embodiments, the demultiplexers (DMUX1˜DMUXn) may receive scan signals from the scan driver 120. Each of the demultiplexers (DMUX1˜DMUXn) may respond to the selection signal (CLA) to output the scan signal received from the scan driver 120 by time sharing. For example, in the first period of the first horizontal period, each of the demultiplexers (DMUX1˜DMUXn) may output the received scan signal to the first and third unit areas (AR1, AR3) in response to the selection signal (CLA). In the second period of the first horizontal period, each of the demultiplexers (DMUX1˜DMUXn) may output the received scan signal to the second and fourth unit areas (AR2, AR4) in response to the selection signal (CLA).

As an specific example, during the first period of the first horizontal period, the first demultiplexer (DMUX1) may output the first scan signal received from the scan driver 120 to the first row pixels (PXL11˜PXL1a−1) of the first unit area (AR1) and to the first row pixels (PXL1b˜PXL1c−1) of the third unit area (AR3). During the second period of the first horizontal period following the first period of the first horizontal period, the first demultiplexer (DMUX1) may output the first scan signal received from the scan driver 120 to the first row pixels (PXL1a˜PXL1b−1) of the second unit area (AR2) and the first row pixels (PXL1c˜PXL1m) of the fourth unit area (AR4).

During the first period of a second horizontal period following the second period of the first horizontal period, the second demultiplexer (DMUX2) may output the second scan signal received from the scan driver 120 to the second row pixels (PXL21˜PXL2a−1) of the first unit area (AR1) and the second row pixels (PXL2b˜PXL2c−1) of the third unit area (AR3). During the second period of the second horizontal period following the first period of the second horizontal period, the second demultiplexer (DMUX2) may output the second scan signal received from the scan driver 120 to the second row pixels (PXL2a˜PXL2b−1) of the second unit area (AR2) and the second row pixels (PXL2c˜PXL2m) of the fourth unit area (AR4).

As such, the scan output unit 160 may output the scan signals received from the scan driver 120 to pixels divided by unit area by time sharing. Accordingly, at each shared time, the driver integrated circuit may perform data processing and driving for the unit area that receives the scan signal, without data processing and driving for the unit area that does not receive the scan signal. As a result, the resources consumed to drive the data lines in each unit area may be relatively reduced. Thus, it may be possible to relatively reduce the number of driver integrated circuits required for a plurality of unit areas (AR1˜AR4) while maintaining the existing resolution. Thereby, it may be possible to facilitate integration of the display device (DD). In addition, by minimizing or reducing the number of driver integrated circuits, it may be possible to relatively reduce the output deviation and static power between the driver integrated circuits. As a result, it may be possible to relatively improve the poor image quality of the display device (DD) due to the deviation in the output between the driver integrated circuits.

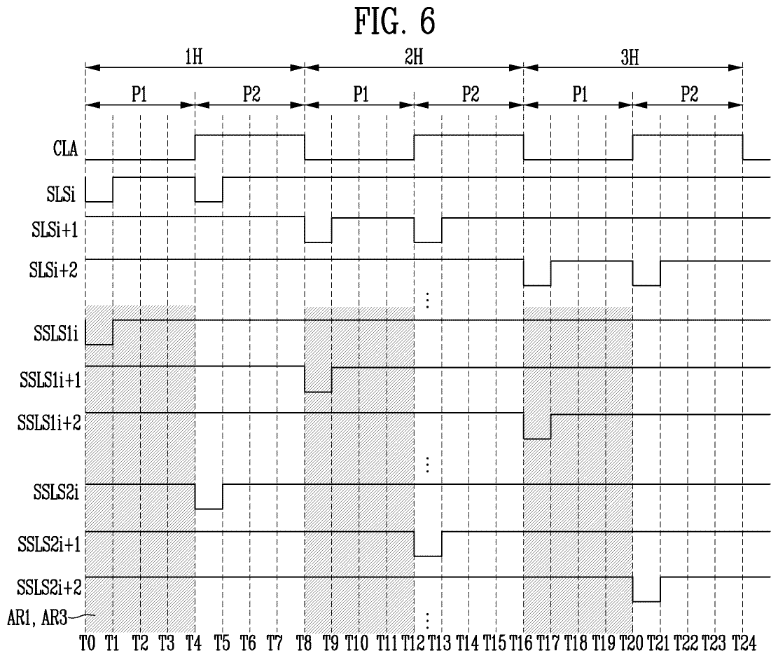

FIG. 6 is a timing diagram illustrating signals associated with a scan output unit of FIG. 5. In FIG. 6, for a clear and concise explanation, illustratively shown are the i-th scan signal (SLSi), the (i+1)-th scan signal (SLSi+1), and the (i+2)-th scan signal (SLSi+2) that are provided in each of the scan lines of the i-th to (i+2)-th rows of the scan lines (SL1˜SLn). Illustratively shown are the (1_i)-th sub-scan signal (SSLS1i), the (1_i+1)-th sub-scan signal (SSLS1i+1), and the (1_i+2)-th sub-scan signal (SSLS1i+2) that are applied to each of first sub-scan lines of the i-th to (i+2)-th rows among the first sub-scan lines (SSL11˜SSLn1). In addition, illustratively shown are the (2_i)-th sub-scan signal (SSLS2i), the (2_i+1)-th sub-scan signal (SSLS2i+1), and the (2_i+2)-th sub-scan signal (SSLS2i+2) that are applied to each of the second sub-scan lines (SSL12˜SSLn2) of the i-th to (i+2)-th rows among the second sub-scan lines (SSL12˜SSLn2).

According to some embodiments, the scan output unit 160 may output the i-th scan signal (SLSi), the (i+1)-th scan signal (SLSi+1), and the (i+2)-th scan signal (SLSi+2) received based on the selection signal (CLA) by time sharing in each horizontal period. Each of the first to third horizontal periods (1H˜3H) may include the first period (P1) and the second period (P2) that are consecutive.

The selection signal (CLA) may include voltages of a first logic level (or, a low level) and a second logic level (or a high level). The selection signal (CLA) may alternately have the first logic level and the second logic level in each horizontal period. For example, the selection signal (CLA) may have a low level during the first period (P1) of the first horizontal period (1H) and a high level during the second period (P2) of the first horizontal period (1H). The selection signal (CLA) may have a low level during the first period (P1) of the second horizontal period (2H) and a high level during the second period (P2) of the second horizontal period (2H). In addition, the selection signal (CLA) may have a low level during the first period (P1) of a third horizontal period (3H) and a high level during the second period (P2) of the third horizontal period (3H).

Referring to FIG. 5 and FIG. 6, during the first period (P1) of the first horizontal period (1H), the selection signal (CLA) with a low level may be input to the i-th demultiplexer (DMUXi). In this case, the i-th demultiplexer (DMUXi) may output the i-th scan signal (SLSi) to the first sub-scan line in the i-th row. During the first period (P1) of the first horizontal period (1H), the (1_i)-th sub-scan signal (SSLS1i) that is output to the first sub-scan line in the i-th row may be identical to the i-th scan signal (SLSi). For example, during the first period (P1) of the first horizontal period (1H), the (1_i)-th sub-scan signal (SSLS1i) may have a low level from a zeroth time (T0) to a first time (T1), and a high level from the first time (T1) to a fourth time (T4). The (1_i)-th sub-scan signal (SSLS1i) may include a low-level voltage in the first period (P1) of the first horizontal period (1H).

During the second period (P2) of the first horizontal period (1H), the selection signal (CLA) having a high level may be input to the i-th demultiplexer (DMUXi). In this case, the i-th demultiplexer (DMUXi) may output the i-th scan signal (SLSi) to the second sub-scan line of the i-th row. During the second period (P2) of the first horizontal period (1H), the (2_i)-th sub-scan signal (SSLS2i) output to the first sub-scan line of i-th row may be identical to the i-th scan signal (SLSi). For example, during the second period (P2) of the first horizontal period (1H), the (2_i)-th sub-scan signal (SSLS2i) may have a low level from the fourth time (T4) to a fifth time (T5) and a high level from the fifth time (T5) to an eighth time (T8). The (2_i)-th sub-scan signal (SSLS2i) may include a low-level voltage in the second period (P2) of the first horizontal period (1H).

During the first period (P1) of the second horizontal period (2H), the selection signal (CLA) with a low level may be input to the (i+1)-th demultiplexer (DMUXi+1). In this case, the (i+1)-th demultiplexer (DMUXi+1) may output the (i+1)-th scan signal (SLSi+1) to the first sub-scan line of the (i+1)-th row. During the first period (P1) of the second horizontal period (2H), the (1_i+1)-th sub-scan signal (SSLS1i+1) output to the first sub-scan line of the (i+1)-th row may be identical to the (i+1)-th scan signal (SLSi+1). For example, during the first period (P1) of the second horizontal period (2H), the (1_i+1)-th sub-scan signal (SSLS1i+1) may have a low level from the eighth time (T8) to a ninth time (T9) and a high level from the ninth time (T9) to a twelfth time (T12). The (1_i+1)-th sub-scan signal (SSLS1i+1) may include a low-level voltage in the first period (P1) of the second horizontal period (2H).

During the second period (P2) of the second horizontal period (2H), the selection signal (CLA) with a high level may be input to the (i+1)-th demultiplexer (DMUXi+1). In this case, the (i+1)-th demultiplexer (DMUXi+1) may output the (i+1)-th scan signal (SLSi+1) to the second sub-scan line of the (i+1)-th row. During the second period (P2) of the second horizontal period (2H), the (2_i+1)-th sub-scan signal (SSLS2i+1) output to the second sub-scan line of the (i+1)-th row may be identical to the (i+1)-th scan signal (SLSi+1). For example, during the second period (P2) of the second horizontal period (2H), the (2_i+1)-th sub-scan signal (SSLS2i+1) may have a low level from the twelfth time (T12) to a thirteenth time (T13) and a high level from the thirteenth time (T13) to a sixteenth time (T16). The (2_i+1)-th sub-scan signal (SSLS2i+1) may include a low-level voltage in the second period (P2) of the second horizontal period (2H).

During the first period (P1) of the third horizontal period (3H), the selection signal (CLA) with a low level may be input to the (i+2)-th demultiplexer (DMUXi+2). In this case, the (i+2)-th demultiplexer (DMUXi+2) may output the (i+2)-th scan signal (SLSi+2) to the first sub-scan line of the (i+2)-th row. During the first period (P1) of the third horizontal period (3H), the (1_i+2)-th sub-scan signal (SSLS1i+2) output to the first sub-scan line of the (i+2)-th row may be identical to the (i+2)-th scan signal (SLSi+2). For example, during the first period (P1) of the third horizontal period (3H), the (1_i+2)-th sub-scan signal (SSLS1i+2) may have a low level from the sixteenth time (T16) to a seventeenth time (T17) and a high level from the seventeenth time (T17) to a twentieth time (T20). The (1_i+2)-th sub-scan signal (SSLS1i+2) may include a low-level voltage in the first period (P1) of the third horizontal period (3H).

During the second period (P2) of the third horizontal period (3H), the selection signal (CLA) with a high level may be input to the (i+2)-th demultiplexer (DMUXi+2). In this case, the (i+2)-th demultiplexer (DMUXi+2) may output the (i+2)-th scan signal (SLSi+2) to the second sub-scan line of the (i+2)-th row. During the second period (P2) of the third horizontal period (3H), the (2_i+2)-th sub-scan signal (SSLS2i+2) output to the second sub-scan line of the (i+2)-th row may be identical to the (i+2)-th scan signal (SLSi+2). For example, during the second period (P2) of the third horizontal period (3H), the (2_i+2)-th sub-scan signal (SSLS2i+2) may have a low level from the twentieth time (T20) to a twenty-first time (T21) and a high level from the twenty-first time (T21) to a twenty-fourth time (T24). The (2_i+2)-th sub-scan signal (SSLS2i+2) may include a low-level voltage in the second period (P2) of the third horizontal period (3H).

According to some embodiments, during the first period (P1) of each of the first horizontal period (1H), the second horizontal period (2H), and the third horizontal period (3H), the scan output unit 160 may output the scan signal to the first sub-scan lines (SSL11˜SSLn1). Here, the first sub-scan lines (SSL11˜SSLn1) may be connected to the pixels of the first and third unit areas (AR1, AR3). Thus, during the first period (P1) of each of the first horizontal period (1H), the second horizontal period (2H), and the third horizontal period (3H), the scan driver 120 may provide scan signals to the pixels of the first and third unit areas (AR1, AR3) through the scan output unit 160.

During the second period (P2) of each of the first horizontal period (1H), the second horizontal period (2H), and the third horizontal period (3H), the scan output unit 160 may output the scan signal to the second sub-scan lines (SSL12˜SSLn2). Here, the second sub-scan lines (SSL12˜SSLn2) may be connected to the pixels of the second and fourth unit areas (AR2, AR4). Thus, during the second period (P2) of each of the first horizontal period (1H), the second horizontal period (2H), and the third horizontal period (3H), the scan driver 120 may provide scan signals to the pixels of the second and fourth unit areas (AR2, AR4) through the scan output unit 160.

For example, during the first period (P1) of the first horizontal period (1H), the scan output unit 160 may output the scan signal to the pixels arranged in the i-th row of the first and third unit areas (AR1, AR3). During the second period (P2) of the first horizontal period (1H), the scan output unit 160 may output the scan signal to the pixels arranged in the i-th row of the second and fourth unit areas (AR2, AR4). During the first period (P1) of the second horizontal period (2H), the scan output unit 160 may output the scan signal to the pixels arranged in the (i+1)-th row of the first and third unit areas (AR1, AR3). During the second period (P2) of the second horizontal period (2H), the scan output unit 160 may output the scan signal to the pixels arranged in the (i+1)-th row of the second and fourth unit areas (AR2, AR4). During the first period (P1) of the third horizontal period (3H), the scan output unit 160 may output the scan signal to the pixels arranged in the (i+2)-th row of the first and third unit areas (AR1, AR3). During the second period (P2) of the third horizontal period (3H), the scan output unit 160 may output the scan signal to the pixels arranged in the (i+2)-th row of the second and fourth unit areas (AR2, AR4).

Thus, the scan output unit 160 may output the scan signal to one of the first and second sub-scan lines connected to the same pixel row by time sharing according to the selection signal (CLA). Thus, during the first and second periods (P1, P2) of consecutive horizontal periods, the scan output unit 160 may alternately output the scan signal to the pixels of the first and third unit areas (AR1, AR3) and the pixels of the second and fourth unit areas (AR2, AR4).

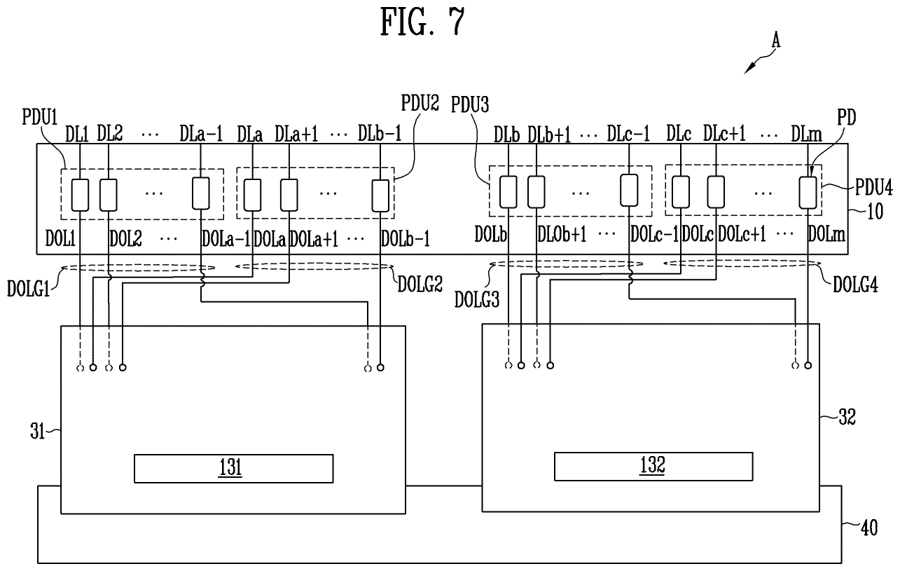

FIG. 7 is a block diagram illustrating aspects of a portion of a display panel and a data driver.

Referring to FIG. 2 and FIG. 7, the first and second flexible films 31 and 32 may be attached to the display panel 10 and the first printed circuit board 40. In FIG. 7, to illustrate the connection between the data output lines (DOL1˜DOLm) and the data lines (DL1˜DLm), the first and second flexible films 31 and 32 and the display panel 10 are shown as being spaced apart. However, embodiments are not limited thereto. The display panel 10 and/or first to fourth pad units (PDU1˜PDU4) may overlap with the first and second flexible films 31 and 32.

The data driver 130 may be mounted on the first and second flexible films 31 and 32 as driver integrated circuits 131 and 132.

The first and second flexible films 31 and 32 may each include a first layer and a second layer provided on the first layer. The first and second layers may be those selected as needed from among the plurality of layers included in each of the first and second flexible films 31 and 32. For example, a third layer may be located between the first and second layers. Here, the third layer may include an insulating material.

According to some embodiments, the first flexible film 31 may include first and second group data output lines (DOLG1, DOLG2) connected to the first driver integrated circuit 131. Here, the first group data output lines (DOLG1) may include the first to (a−1)-th data output lines (DOL1˜DOLa−1). The second group data output lines (DOLG2) may include a-th to (b−1)-th data output lines (DOLa˜DOLa−1).

The first group data output lines (DOLG1) may be included in the first layer of the first flexible film 31, and the second group data output lines (DOLG2) may be included in the second layer of the first flexible film 31. However, embodiments are not limited thereto. For example, the first group data output lines (DOLG1) may be included in the second layer of the first flexible film 31, and the second group data output lines (DOLG2) may be included in the first layer of the first flexible film 31.

The second flexible film 32 may include third and fourth group data output lines (DOLG3, DOLG4) connected to the second driver integrated circuit 132. Here, the third group data output lines (DOLG3) may include b-th to (c−1)-th data output lines (DOLb˜DOLc−1). The fourth group data output lines (DOLG4) may include c-th to m-th data output lines (DOLc˜DOLm).

The third group data output lines (DOLG3) may be included in the first layer of the second flexible film 32, and the fourth group data output lines (DOLG4) may be included in the second layer of the second flexible film 32. However, embodiments are not limited thereto. For example, the third group data output lines (DOLG3) may be included in the second layer of the second flexible film 32, and the fourth group data output lines (DOLG4) may be included in the first layer of the second flexible film 32.

The display panel 10 may include the first to fourth pad units (PDU1˜PDU4). The first to fourth pad units (PDU1˜PDU4) may be located on one side of the display panel 10. The first and second pad units (PDU1, PDU2) may correspond to the first flexible film 31. The first and second pad units (PDU1, PDU2) may come into contact with the first flexible film 31. Here, the first pad unit (PDU1) may include pads that are connected to the first group data lines (DL1˜DLa−1) connected to the pixels of the first unit area (AR1, see FIG. 5) of the pads (PD). The second pad unit (PDU2) may be connected to the second group data lines (DLa˜DLb−1) that are connected to the pixels of the second unit area (AR2, see FIG. 5) of the pads (PD).

The first pad unit (PDU1) may be connected to the first group data output lines (DOLG1) of the first flexible film 31 and the first group data lines (DL1˜DLa−1) of the display panel 10. Thus, the data voltages output from the first driver integrated circuit 131 may be provided to the first group data lines (DL1˜DLa−1) that are connected to the pixels of the first unit area (AR1) through the first pad unit (PDU1).

The second pad unit (PDU2) may be connected to the second group data output lines (DOLG2) of the first flexible film 31 and the second group data lines (DLa˜DLb−1) of the display panel 10. Thus, the data voltages output from the first driver integrated circuit 131 may be provided to the second group data lines (DLa˜DLb−1) that are connected to the pixels of the second unit area (AR2) through the second pad unit (PDU2).

The third and fourth pad units (PDU3, PDU4) may correspond to the second flexible film 32. The third and fourth pad units (PDU3, PDU4) may come into contact with the second flexible film 32. Here, the third pad unit (PDU3) may include pads that are connected to the third group data lines (DLb˜DLc−1) connected to the pixels of the third unit area (AR3, see FIG. 5) of the pads (PD). The fourth pad unit (PDU4) may be connected to the fourth group data lines (DLc˜DLm) that are connected to the pixels of the fourth unit area (AR4, see FIG. 5) of the pads (PD).

The third pad unit (PDU3) may be connected to the third group data output lines (DOLG3) of the second flexible film 32 and the third group data lines (DLb˜DLc−1) of the display panel 10. Thus, the data voltages output from the second driver integrated circuit 132 may be provided to the third group data lines (DLb˜DLc−1) that are connected to the pixels of the third unit area (AR3) through the third pad unit (PDU3).

The fourth pad unit (PDU4) may be connected to the fourth group data output lines (DOLG4) of the second flexible film 32 and the fourth group data lines (DLc˜DLm) of the display panel 10. Thus, the data voltages output from the second driver integrated circuit 132 may be provided to the fourth group data lines (DLc˜DLm) that are connected to the pixels of the fourth unit area (AR4) through the fourth pad unit (PDU4).

Thus, in the first flexible film 31, the first group data output lines (DOLG1) and the second group data output lines (DOLG2) may be located in different layers. In this case, noise components generated by the data voltages from each of the first and second group data output lines (DOLG1, DOLG2) may relatively reduce the effect on the different output lines. In addition, by arranging the first and second group data output lines (DOLG1, DOLG2) through division into a plurality of layers, the size of the flexible film may be relatively reduced, and the integration of the display device (DD) may be facilitated.

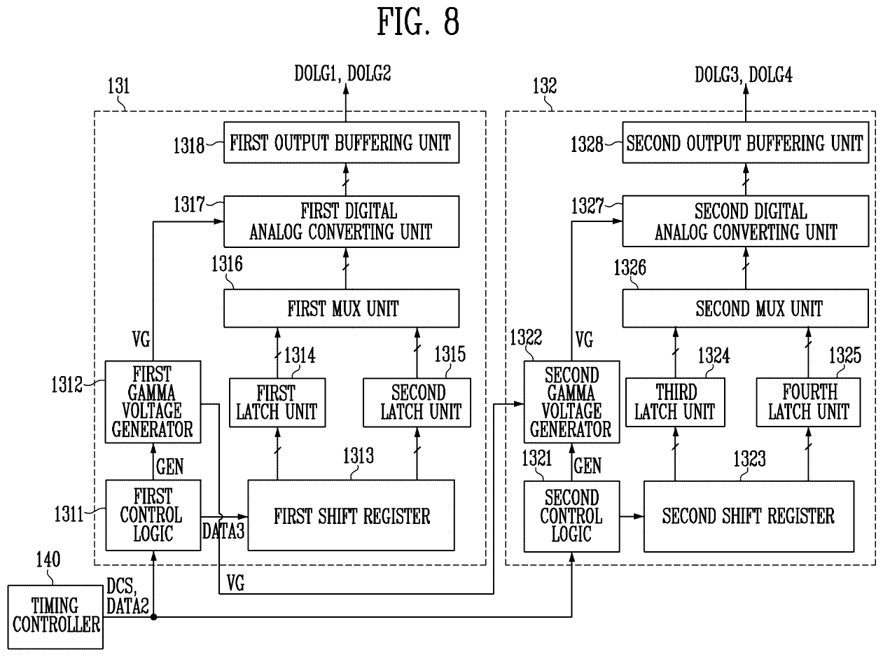

FIG. 8 is a block diagram illustrating aspects of a data driver of FIG. 2.

Referring to FIG. 2 and FIG. 8, the data driver 130 may be included in the driver integrated circuits 131 and 132. The first driver integrated circuit 131 may include a first controller 1311 (or a first control logic), a first gamma voltage generator 1312, the first shift register 1313, first and second latch units 1314, 1315, a first mux unit 1316, a first digital analog converting unit 1317, and a first output buffering unit 1318. For example, the data driver 130 included in the first driver integrated circuit 131 may be configured to provide data voltages to the pixels arranged in the first and second unit areas (AR1, AR2) of FIG. 5.

The first controller 1311 may receive the data control signal (DCS) from the timing controller 140 and the image data corresponding to the first and second unit areas (AR1, AR2). The first controller 1311 may receive various control signals from the timing controller 140.

The first controller 1311 may change the serialized image data (DATA2) received from timing controller 140 (DATA2) to parallelized data (DATA3). The parallelized data (DATA3) may be the those that are segmented in a scan line unit of serialized image data (DATA2) based on a horizontal synchronous signal (Hsync). The first controller 1311 may provide the parallelized data (DATA3) to the first shift register 1313.

The first controller 1311 may generate a gamma enabling signal (GEN). The first gamma voltage generator 1312 may receive gamma enabling signals (GEN) and generate gamma voltages (VG) having various voltage levels. Here, gamma voltages (VG) may be used to convert image data (DATA2) to data voltage (or gray scale voltage). However, gamma voltages (VG) may include 2048 gamma voltages corresponding to 11-bit data, but the embodiments are not limited thereto. The first gamma voltage generator 1312 may transmit gamma voltages (VG) to a second gamma voltage generator 1322. The first and second gamma voltage generators 1312, 1322 may share gamma voltages (VG) and apply based on the same gamma voltages (VG).

The first shift register 1313 may store the parallelized data (DATA3) provided from the first controller 1311 based on the horizontal synchronous signal (Hsync). Further, the first controller 1311 may provide the parallelized data (DATA3) sequentially to the first and second latch units 1314, 1315.

The first and second latch units 1314, 1315 may receive the parallelized data (DATA3) sequentially from the first shift register 1313 to latch or store the data temporarily. The parallelized data (DATA3) may be stored sequentially on the first and second latch units 1314, 1315 to fit the position to be output to the display panel (DP, see FIG. 2). For example, the first latch unit 1314 may latch the segmented image data corresponding to the first group data lines (DL1˜DLa−1, see FIG. 5) that are connected to the pixels of the first unit area (AR1). The second latch unit 1315 may latch the segmented image data corresponding to the second group data lines (DLa˜DLb−1, see FIG. 5) that are connected to the pixels of the second unit area (AR2). Here, the segmented image data may be those that may be displayed as pixels (PXL) corresponding to a single horizontal line in any one area of the first and second unit areas (AR1, AR2) applied during each horizontal segment.

The first and second latch units 1314, 1315 may output line image data to the first mux unit 1316. Here, the line image data may be segmented image data divided by data lines.

The first mux unit 1316 may receive line image data from the first and second latch units 1314, 1315. The first mux unit 1316 may optionally output the received line image data to the first digital analog converting unit 1317. For example, the first mux unit 1316 may select and output line image data corresponding to the pixels of the first unit area (AR1) received from the first latch unit 1314 during the first periods (P1, see FIG. 6) of each of the horizontal periods. The first mux unit 1316 may select and output line image data corresponding to the pixels of the second unit area (AR2) received from the second latch unit 1315 during the second periods (P2, see FIG. 6) of each of the horizontal periods. To this end, the first mux unit 1316 may include multiplexers that select and output any one of the line image data received from the first and second latch units 1314, 1315.

The first digital analog converting unit 1317 may convert line image data in digital form to analog data voltages using gamma voltages (VG). To this end, the first digital analog converting unit 1317 may include digital analog converters corresponding to the data lines. The first digital analog converting unit 1317 may select at least one of the gamma voltages (VG) according to the gray scale values of the line image data corresponding to the first unit area (AR1) corresponding to the output of the first mux unit 1316. The data voltages selected by the first digital analog converting unit 1317 may be provided to the first output buffering unit 1318. The first digital analog converting unit 1317 may select at least one of the gamma voltages (VG) according to the gray scale values of the line image data corresponding to the second unit area (AR2) according to the output of the first mux unit 1316. The data voltages selected by the first digital analog converting unit 1317 may be provided to the first output buffering unit 1318.

The first output buffering unit 1318 may output the data voltages selected from the first digital analog converting unit 1317 through the first group data output lines (DOLG1) or the second group data output lines (DOLG2). For example, the first output buffering unit 1318 may output data voltages selected during the first period (P1) of each of the horizontal periods to the first group data output lines (DOLG1). The first output buffering unit 1318 may output the data voltages selected during the second period (P2) of each of the horizontal periods to the second group data output lines (DOLG2). The first output buffering unit 1318 may be connected between the first digital analog converting unit 1317 and the first and second group data output lines (DOLG1, DOLG2) and include amplifiers operating as a unit buffer.

The second driver integrated circuit 132 may include a second controller 1321 (or a second control logic), a second gamma voltage generator 1322, a second shift register 1323, third and fourth latch units 1324 and 1325, a second mux unit 1326, a second digital analog converting unit 1327, and a second output buffering unit 1328. For example, the data driver 130 included in the second driver integrated circuit 132 may be configured to provide data voltages to the pixels arranged in the third and fourth unit areas (AR3, AR4) of FIG. 5. The second driver integrated circuit 132 may be configured as the first driver integrated circuit 131. Hereinafter, the duplicated description will be omitted.

The second controller 1321 may receive the data control signal (DCS) and the image data corresponding to the third and fourth unit areas (AR3, AR4) from the timing controller 140.

The third and fourth latch units 1324 and 1325 may receive the parallelized data (DATA3) sequentially from the second shift register 1323 to latch or store the data temporarily. The parallelized data (DATA3) may be stored sequentially in the third and fourth latch units 1324 and 1325 to fit the position to be output to the display panel (DP). For example, the second latch unit 1324 may latch segmented image data corresponding to third group data lines (DLb˜DLc−1, see FIG. 5) connected to the pixels of the third unit area (AR3). The fourth latch unit 1325 may latch the segmented image data corresponding to the fourth group data lines (DLc˜DLm) that are connected to the pixels of the fourth unit area (AR4). Here, the segmented image data may be image data that may be displayed in the pixels (PXL) corresponding to a single horizonal line in any one area of the third and fourth unit areas (AR3, AR4) applied during each horizontal segment.

The second mux unit 1326 may receive line image data from the third and fourth latch units 1324 and 1325. The second mux unit 1326 may optionally output the received line image data to the second digital analog converting unit 1327. For example, the second mux unit 1326 may select and output line image data corresponding to the pixels of the third unit area (AR3) received from the third latch unit 1324 during the first period (P1) of each of the horizontal periods. The second mux unit 1326 may select and output line image data corresponding to the pixels of the fourth unit area (AR4) received from the fourth latch unit 1325 during the second period (P2) of each of the horizontal periods. The second digital analog converting unit 1327 may select at least one of the gamma voltages (VG) according to the gray scale values of the line image data corresponding to the third unit area (AR3) according to the output of the second mux unit 1326. The data voltages selected by the second digital analog converting unit unit 1327 may be provided to the second output buffering unit 1328. The second digital analog converting unit 1327 may select at least one of the gamma voltages (VG) according to the gray scale values of the line image data corresponding to the fourth unit area (AR4). The data voltages selected by the second digital analog converting unit 1327 may be provided to the second output buffering unit 1328.

The second output buffering unit 1328 may output the data voltage selected from the second digital analog converting unit 1327 through the third group data output lines (DOLG3) or the fourth group data output lines (DOLG4). For example, the second output buffering unit 1328 may output data voltages selected during the first period (P1) of each of the horizontal periods to the third group data output lines (DOLG3). The second output buffering unit 1328 may output data voltages selected during the second period (P2) of each of the horizontal periods to the fourth group data output lines (DOLG4).

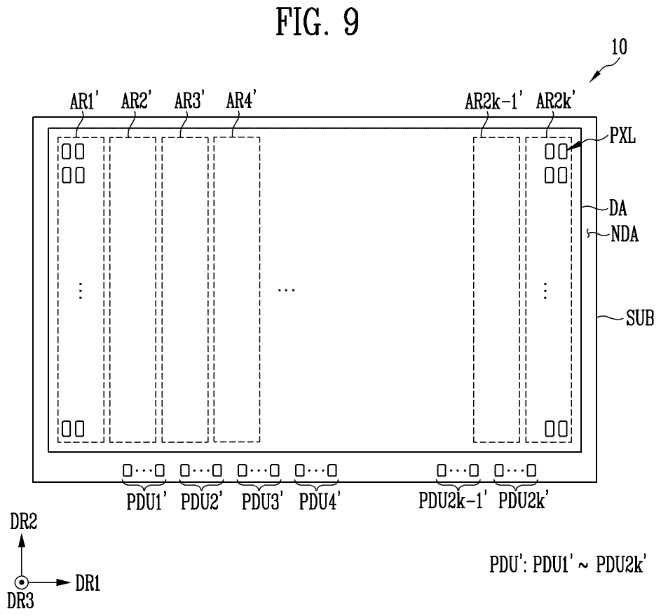

FIG. 9 is a plan view illustrating further details of a plurality of unit areas included in a display panel of FIG. 2.

Referring to FIG. 9, the substrate (SUB), the display area (DA), the non-display area (NDA), and the pixels (PXL) may be configured as described in reference to FIG. 4. Hereinafter, the duplicated description will be omitted.

Referring to FIG. 9, the pixels (PXL) of the display panel (DP) may be divided into first to 2k-th unit areas (AR1′˜AR2k′, where k is a positive integer greater than or equal to 3). For example, if the display device (DD) includes k driver integrated circuits, the pixels (PXL) may be divided into the first to 2k-th unit areas (AR1′˜AR2k′). As shown in FIG. 9, the first to 2k-th unit areas (AR1′˜AR2k′) may be arranged side by side along the first direction (DR1). However, it is not limited thereto. For example, the first to 2k-th unit areas (AR1′˜AR2k′) may be arranged side by side along the second direction (DR2).

According to some embodiments, pad units (PDU') may include first to 2k-th pad units (PDU1′-PDU2k′). The first pad unit (PDU1′) may be connected to the data lines that are connected to the pixels of the first unit area (AR1′). The second pad unit (PDU2′) may be connected to the data lines that are connected to the pixels of the second unit area (AR2′). The third pad unit (PDU3′) may be connected to the data lines that are connected to the pixels of the third unit area (AR3′). The fourth pad unit (PDU4′) may be connected to the data lines that are connected to the pixels of the fourth unit area (AR4′). The (2k−1)-th pad unit (PDU2k−1′) may be connected to the data lines that are connected to the pixels of the (2k−1)-th unit area (AR2k−1′). The 2k-th pad unit (PDU2k′) may be connected to the data lines that are connected with the pixels of the 2k-th area (AR2k′).

The scan signals may be optionally provided in the first to 2k-th unit areas (AR1′˜AR2k′) of the display panel 10. For example, the scan signals may be provided to pixels in the odd number-ordered unit areas during a single period included in the horizontal period, and the scan signals may be provided to pixels in even number-ordered unit areas during another period included in the same horizontal period. For example, the scan signal may be provided to the pixels in the first unit area (AR1′), the third unit area (AR3′), and the (2k−1)-th unit area (AR2k−1′) during the first period of the first horizontal period. Then, during the second period of the first horizontal period following the first period of the first horizontal period, the scan signal may be provided to the pixels in the second unit area (AR2′), the fourth unit area (AR4′), and the 2k-th unit area (AR2k′).

As such, the number of unit areas dividing the pixels (PXL) of the display panel (DP) may vary according to the embodiments.

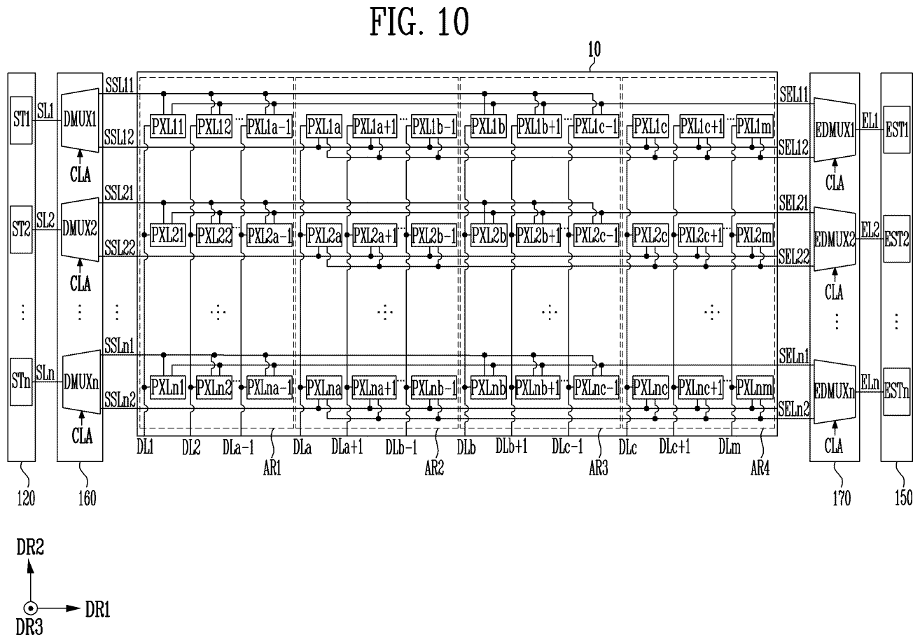

FIG. 10 is a block diagram illustrating aspects of an emission driver and an emission output unit of FIG. 2.

Referring to FIG. 10, the display device (DD) may include the display panel 10, the scan driver 120, the scan output unit 160, the emission driver 150, and an emission output unit 170. The scan driver 120 and the scan output unit 160 may be configured as described in reference to FIG. 5. Hereinafter, the duplicated description will be omitted.

The pixels (PXL11˜PXLnm) of the display panel 10 may be connected to the first sub-emission control lines (SEL11˜SELn1) and the second sub-emission control lines (SEL12˜SELn2). Here, the first sub-emission control lines (SEL11˜SELn1) and the second sub-emission control lines (SEL12˜SELn2) may extend in the first direction (DR1) to be arranged in parallel to each other. The first sub-emission control lines (SEL11˜SELn1) and the second sub-emission control lines (SEL12˜SELn2) may be arranged to cross the data lines (DL1˜DLm) (e.g., in a plan view).

The pixels (PXL11˜PXL1a−1, PXL21˜PXL2a−1, . . . , PXLn1˜PXLna−1) of the first unit area (AR1) may be connected to the first sub-emission control lines (SEL11˜SELn1). The pixels (PXL1a˜PXL1b−1, PXL2aPXL2b−1, . . . , PXLna˜PXLnb−1) of the second unit area (AR2) may be connected to the second sub-emission control lines (SSL12˜SSLn2). The pixels (PXL1b˜PXL1c−1, PXL2bPXL2c−1, . . . , PXLnb˜PXLnc−1) of the third unit area (AR3) may be connected to the first sub-emission control lines (SEL11˜SELn1). In addition, the pixels (PXL1c˜PXL1m, PXL2cPXL2m, . . . , PXLnc˜PXLnm) of the fourth unit area (AR4) may be connected to the second sub-emission control lines (SSL12˜SSLn2).

The emission driver 150 may be connected to a plurality of emission control lines (EL1˜ELn) and generate emission control signals according to the emission driving control signal (ECS, see FIG. 2) to provide to the emission control lines (EL1˜ELn).

The emission driver 150 may include a plurality of light emitting stages (EST1˜ESTn) (or light emitting stage circuits). The light emitting stages (EST1˜ESTn) may each be connected to the emission control lines (EL1˜ELn), and the light emitting stages (EST1˜ESTn) may provide the scan signals to the emission control lines (EL1˜ELn) sequentially. For example, the first light emitting stage (EST1) may provide the first emission control signal to the first emission control line (ESL1). The second light emitting stage (EST2) may provide the second emission control signal to the second emission control line (ESL2). The n-th light emitting stage (ESTn) may provide the n-th emission control signal to the n-th emission control line (ESLn). For example, the emission driver 150 may include n light emitting stages (EST1˜ESTn) corresponding to n pixel rows.

The emission output unit 170 may be connected between the emission driver 150 and the display panel 10. The emission output unit 170 may optionally output the emission control signals provided from the emission driver 150 to the first to fourth unit areas (AR1˜AR4) of the display panel 10.

The emission output unit 170 may output the emission control signal received from the emission driver 150 to the pixels (PXL11˜PXL1a−1, PXL21˜PXL2a−1, . . . , PXLn1˜PXLna−1) of the first unit area (AR1) and the pixels (PXL1b˜PXL1c−1, PXL2bPXL2c−1, . . . , PXLnb˜PXLnc−1) of the third unit area (AR3) during the first period of a single horizontal period. In addition, the scan output unit 160 may output the emission control signal received from the emission driver 150 to the pixels (PXL1a˜PXL1b−1, PXL2aPXL2b−1, PXLna˜PXLnb−1) of the second unit area (AR2) and the pixels (PXL1c˜PXL1m, PXL2cPXL2m, . . . , PXLnc˜PXLnm) of the fourth unit area (AR4) during the second period of a single horizontal period.

The emission output unit 170 may include demultiplexers (EDMUX1˜EDMUXn). The emission output unit 170 may include demultiplexers (EDMUX1˜EDMUXn) that are connected to the emission control lines (EL1˜ELn) and sub-emission control lines (SEL11˜SELn1, SEL12˜SELn2). For example, the demultiplexers (EDMUX1˜EDMUXn) may have one input terminal and two output terminals. Here, the input terminal may be connected to one of the emission control lines (EL1˜ELn) to allow the emission control signals to be input. In addition, the output terminals may be connected to one of the first sub-emission control lines (SEL11˜SELn1) and one of the second sub-emission control lines (SEL12˜SELn2) to optionally output emission control signals. Each of the demultiplexers (EDMUX1˜EDMUXn) may output the scan signal by time sharing through the corresponding output terminals in response to the selection signal (CLA). More specifically, each of the demultiplexers (EDMUX1˜EDMUXn) may output the emission control signal input to one input terminal to the output terminal selected by the selection signal (CLA) of two output terminals. For example, the emission output unit 170 may include n demultiplexers (EDMUX1˜EDMUXn) corresponding to n pixel rows.

For example, the demultiplexers (EDMUX1˜EDMUXn) may be connected to the light emitting stages (EST1˜ESTn) through emission control lines (EL1˜ELn). For example, the first demultiplexer (EDMUX1) may be connected to the first light emitting stage (EST1) through the first emission control line (ESL1). The second demultiplexer (EDMUX2) may be connected to the second light emitting stage (EST2) through the second emission control line (ESL2). The n-th demultiplexer (EDMUXn) may be connected to the n-th light emitting stage (ESTn) through the n-th emission control line (ESLn).

According to some embodiments, the demultiplexers (EDMUX1˜EDMUXn) may be connected to pixels located in the first and third unit areas (AR1, AR3) through first sub-emission control lines (SEL11˜SELn1). In addition, the demultiplexers (EDMUX1˜EDMUXn) may be connected to the pixels located in the second and fourth unit areas (AR2, AR4) through the second sub-emission control lines (SEL12˜SELn2).

For example, the first demultiplexer (EDMUX1) may be connected to the first row pixels (PXL11˜PXL1a−1) of the first unit area (AR1) and the first row pixels (PXL1b˜PXL1c−1) of the third unit area (AR3) through the first sub-emission control line (SEL11) of the first row. The first demultiplexer (EDMUX1) may be connected to the first row pixels (PXL1a˜PXL1b−1) of the second unit area (AR2) and the first row pixels (PXL1c˜PXL1m) of the fourth unit area (AR4) through the second sub-emission control line (SEL12) of the first row.

The second demultiplexer (EDMUX2) may be connected to the second row pixels (PXL21˜PXL2a−1) of the first unit area (AR1) and the second row pixels (PXL2b˜PXL2c−1) of the third unit area (AR3) through the first sub-emission control line (SEL21) of the second row. The second demultiplexer (EDMUX2) may be connected to the second row pixels (PXL2a˜PXL2b−1) of the second unit area (AR2) and the second row pixels (PXL2c˜PXL2m) of the fourth unit area (AR4) through the second sub-emission control line (SEL22) of the second row.

The n-th demultiplexer (EDMUXn) may be connected to the n-th row pixels (PXLn1˜PXLna−1) of the first unit area (AR1) and the n-th row pixels (PXLnb˜PXLnc−1) of the third unit area (AR3) through the first sub-emission control line (SELn1) of the n-th row. The n-th demultiplexer (EDMUXn) may be connected to the n-th row pixels (PXLna˜PXLnb−1) of the second unit area (AR2) and the n-th row pixels (PXLnc˜PXLnm) of the fourth unit area (AR4) through the second sub-emission control line (SELn2) of the n-th row.

According to some embodiments, each of the demultiplexers (EDMUX1˜EDMUXn) may receive the emission control signal from the emission driver 150. Each of the demultiplexers (EDMUX1˜EDMUXn) may output, by time sharing, the emission control signal received from the emission driver 150 in response to the selection signal (CLA). For example, in the first period of the first horizontal period, each of the demultiplexers (EDMUX1˜EDMUXn) may output the received emission control signal to the first and third unit areas (AR1, AR3) in response to the selection signal (CLA). In the second period of the first horizontal period, each of the demultiplexers (EDMUX1˜EDMUXn) may output the received emission control signal to the second and fourth unit areas (AR2, AR4) in response to the selection signal (CLA). The demultiplexers (EDMUX1˜EDMUXn) of the emission output unit 170 may operate in conjunction with the demultiplexers (DMUX1˜DMUXn) of the scan output unit 160.

As a specific example, during the first period of the first horizontal period, the first demultiplexer (EDMUX1) may output the first emission control signal received from the emission driver 150 to the first row pixels (PXL11˜PXL1a−1) of the first unit area (AR1) and the first row pixels (PXL1b˜PXL1c−1) of the third unit area (AR3). During the second period of the first horizontal period following the first period of the first horizontal period, the first demultiplexer (DMUX1) may output the first emission control signal received from the emission driver 150 to the first row pixels (PXL1a˜PXL1b−1) of the second unit area (AR2) and the first row pixels (PXL1c˜PXL1m) of the fourth unit area (AR4). During the first horizontal period, the first demultiplexer (EDMUX1) of the emission output unit 170 may operate in conjunction with the first demultiplexer (DMUX1) of the scan output unit 160.

During the first period of the second horizontal period following the second period of the first horizontal period, the second demultiplexer (EDMUX2) may output the second scan signal received from the emission driver 150 to the second row pixels (PXL21˜PXL2a−1) of the first unit area (AR1) and the second row pixels (PXL2b˜PXL2c−1) of the third unit area (AR3). During the second period of the second horizontal period following the first period of the second horizontal period, the second demultiplexer (EDMUX2) may output the second scan signal received from the emission driver 150 to the first row pixels (PXL1a˜PXL1b−1) of the second unit area (AR2) and the first row pixels (PXL1c˜PXL1m) of the fourth unit area (AR4). During the second horizontal period, the second demultiplexer (EDMUX2) of the emission output unit 170 may operate in conjunction with the second demultiplexer (DMUX2) of the scan output unit 160.

As such, the emission output unit 170 may output the emission control signals received from the emission driver 150 to the pixels divided by unit area by time sharing. In addition, the emission output unit 170 may operate in conjunction with the scan output unit 160. Accordingly, at each shared time, the driver integrated circuit may perform data processing and driving for the unit area receiving the scan signal and the emission control signal, without data processing and driving for the unit area that does not receive the scan signal and the emission control signal. Thereby, the resources required to drive the data lines in each unit area may be relatively reduced more effectively.

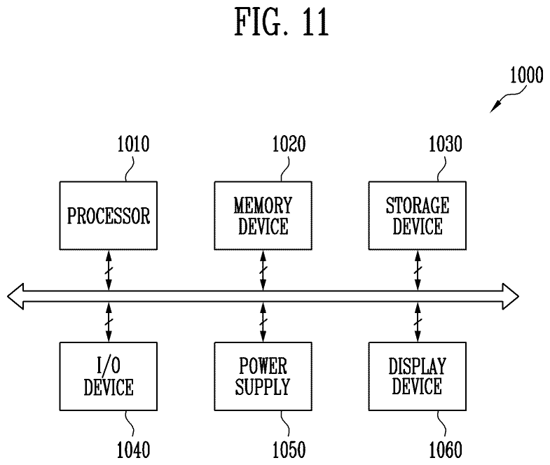

FIG. 11 is a schematic block diagram illustrating aspects of an electronic device including a display device according to some embodiments of the present disclosure.

Referring to FIG. 11, the electronic device 1000 may include a processor 1010, a memory device 1020, a storage device 1030, an I/O device 1040, a power supply 1050, and a display device 1060. The display device 1060 may be the display device (DD) of FIG. 1. In addition, the electronic device 1000 may further include several ports capable of communicating with video cards, sound cards, memory cards, and USB devices, or communicating with other systems. According to some embodiments, the electronic device 1000 may be implemented as a smartphone. According to some embodiments, the electronic device 1000 may be implemented as a tablet PC. However, this is illustrative, and the electronic devices 1000 is not limited thereto. For example, electronic device 1000 may be implemented as mobile phones, video phones, smart pads, smart watches, vehicle navigators, computer monitors, laptops, and head-mounted display devices.

The processor 1010 may perform certain calculations or tasks. According to

some embodiments, the processor 1010 may be a microprocessor, a central processing unit, and an application processor. The processor 1010 may be connected to other components through an address bus, a control bus, and a data bus. According to some embodiments, the processor 1010 may be connected to extended buses such as a Peripheral Component Interconnect (PCI) bus. According to some embodiments, the processor 1010 may provide input image data to the display device 1060, whereby the display device 1060 may display images based on input image data provided from the processor 1010.

The memory device 1020 may store data necessary for the operation of the electronic device 1000. For example, the memory device 1020 may be non-volatile memory devices, such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) devices, a Polymer Random Access Memory (PoRAM) device, a Magnetic Random Access Memory (MRAM), and a Ferroelectric Random Access Memory (FRAM) device, and/or volatile memory devices, such as a Dynamic Random Access Memory (DRAM) device, a Static Random Access Memory (SRAM) device, and a mobile DRAM device.

The storage device 1030 may include a solid state drive (SSD), a hard disk drive (HDD), and a CD-ROM.

The I/O device 1040 may include input means such as keyboards, keypads, touchpads, touchscreens, and mouses as well as output means such as speakers and printers. According to some embodiments, the display device 1060 may be included in the I/O device 1040.

The power supply 1050 may supply the power required for the operation of the electronic device 1000. For example, the power supply 1050 may be a power management integrated circuit (PMIC). According to some embodiments, the power supply 1050 may supply power to the display device 1060.

The display device 1060 may display images corresponding to the visual information of electronic device 1000. The display device 1060 may be connected to other components through the buses or other communication links.

In the display device according to some embodiments of the present disclosure, the display device may control a plurality of display areas by a single driver integrated circuit by providing the scan signals optionally to pixels divided by unit area by time sharing. Thus, it may be possible to reduce the number of driver integrated circuits included in the display device and facilitate the integration of the display device. In addition, by minimizing or reducing the number of driver integrated circuits included in the display device, the output deviation and static power between the driver integrated circuits may be relatively reduced.

According to some embodiments, a display device may have relatively improved efficiency and an electronic device including the same.

The characteristics of embodiments according to the present disclosure are not limited to those described above, and more diverse effects are included in embodiments according to the present specification.

Although specific embodiments and applications are described herein, other embodiments and modifications may be derived from the above description. The spirit of the present disclosure is not limited to these embodiments, but extends to the claims set forth below, various modifications, and equivalents.

What is claimed is:

1. A display device comprising:
a display panel comprising pixels connected to data lines and scan lines, wherein the pixels are divided into first and second unit areas;
a scan driver configured to provide scan signals to the scan lines; and
a scan output unit connected between the scan driver and the display panel and configured to output the scan signals to the first and second unit areas,
wherein the scan output unit is configured to output a first scan signal received from the scan driver to a first pixel in the first unit area of the pixels during a first period of a first horizontal period and to output the first scan signal to a second pixel in the second unit area of the pixels during a second period of the first horizontal period following the first period of the first horizontal period.

2. The display device according to claim 1, further comprising a data driver connected to the pixels through the data lines,
wherein the data driver is configured to provide a first data voltage to the first pixel through a first data line of the data lines during the first period and to provide a second data voltage to the second pixel through a second data line of the data lines during the second period.

3. The display device according to claim 2, further comprising a flexible film,
wherein the display panel further comprises a pad unit on one side of the display panel and comprises a first data pad connected to the first pixel through the first data line of the data lines and a second data pad connected to the second pixel through the second data line of the data lines, and
the flexible film contacts the pad unit.

4. The display device according to claim 3, wherein the data driver is on the flexible film, and
the flexible film comprises a first data output line connected to the first data pad and a second data output line connected to the second data pad.

5. The display device according to claim 4, wherein the flexible film comprises first and second layers,
the first data output line is included in the first layer, and
the second data output line is included in the second layer.

6. The display device according to claim 1, wherein the scan output unit comprises a demultiplexer configured to receive the first scan signal from the scan driver and to output the first scan signal to the first and second pixels in response to a selection signal.

7. The display device according to claim 6, wherein the demultiplexer is configured to receive the first scan signal from the scan driver through one of the scan lines during the first and second periods,
is configured to output the first scan signal to a first sub-scan line connected to the first pixel in response to the selection signal having a first logic level during the first period, and
is configured to output the first scan signal to a second sub-scan line connected to the second pixel in response to the selection signal having a second logic level during the second period.

8. The display device according to claim 7, wherein the first and second pixels are in a same pixel row,
the first pixel is connected to a first data line of the data lines and connected to the demultiplexer through the first sub-scan line, and
the second pixel is connected to a second data line of the data lines and connected to the demultiplexer through the second sub-scan line.

9. The display device according to claim 1, wherein the scan output unit is configured to receive a second scan signal from the scan driver, to output the second scan signal to a third pixel in the first unit area of the pixels during a first period of a second horizontal period following the first horizontal period, and to output the second scan signal to a fourth pixel in the second unit area of the pixels during a second period of the second horizontal period following the first period of the second horizontal period.

10. The display device according to claim 9, wherein the first and second pixels are in a first pixel row, and
the third and fourth pixels are in a second pixel row that is different from the first pixel row.

11. The display device according to claim 10, wherein the first and third pixels are connected to a first data line of the data lines, and the second and fourth pixels are connected to a second data line of the data lines.

12. The display device according to claim 9, wherein the scan output unit comprises a demultiplexer configured to receive the second scan signal from the scan driver and to output the second scan signal to the third and fourth pixels in response to a selection signal.

13. The display device according to claim 1, wherein the scan driver comprises a plurality of scan stages configured to output the scan signals.

14. The display device according to claim 1, wherein the pixels are further connected to emission control lines, and
the display device further comprises an emission driver configured to provide emission control signals to the emission control lines.

15. The display device according to claim 14, further comprising an emission output unit connected between the emission driver and the display panel and is configured to output the emission control signals to the first and second unit areas.

16. The display device according to claim 15, wherein the emission output unit is configured to output a first emission control signal received from the emission driver to the first pixel during the first period and to output the first emission control signal to the second pixel during the second period.

17. The display device according to claim 16, wherein the emission output unit comprises a demultiplexer configured to receive the first emission control signal from the emission driver and to output the first emission control signal to the first and second pixels in response to a selection signal.

18. The display device according to claim 17, wherein the emission output unit is configured to receive the first emission control signal from the emission driver through one of the emission control lines during the first and second periods,
is configured to output the first emission control signal to a first sub-emission control line connected to the first pixel in response to the selection signal having a first logic level during the first period, and
is configured to output the first emission control signal to a second sub-emission control line connected to the second pixel in response to the selection signal having a second logic level during the second period.

19. An electronic device comprising:
a processor; and
a display device configured to display an image based on input image data received from the processor,
wherein the display device comprises:
a display panel comprising pixels that are connected to data lines and scan lines, wherein the pixels are divided into first and second unit areas;
a scan driver providing scan signals to the scan lines; and
a scan output unit connected between the scan driver and the display panel and configured to output the scan signals to the first and second unit areas, and
wherein the scan output unit is configured to output a first scan signal received from the scan driver to a first pixel in the first unit area of the pixels during a first period of a first horizontal period and to output the first scan signal to a second pixel in the second unit area of the pixels during a second period of the first horizontal period following the first period of the first horizontal period.
